(19) United States
(12) Patent Application Publication
(10) Pub. No.: US 2025/0209143 A1
(43) Pub. Date: Jun. 26, 2025

(54) REAL PROPERTY STATE MANAGEMENT SYSTEM

(71) Applicant: Anthony DeBono, III, Babcock Ranch, FL (US)

(72) Inventor: Anthony DeBono, III, Babcock Ranch, FL (US)

(21) Appl. No.: 18/965,791

(22) Filed: Dec. 2, 2024

Related U.S. Application Data
(60) Provisional application No. 63/612,439, filed on Dec. 20, 2023.

(51) Int. Cl. G06F 21/31; G06F 21/62; G06Q 10/20; G06Q 50/163

(52) U.S. Cl. CPC G06F 21/31; G06F 21/6218; G06Q 10/20; G06Q 50/163

(57) ABSTRACT

A real property state management system can include a database containing real property records, an authentication module configured to authenticate a real property owner, an interaction module configured to process interaction requests by an authenticated real property owner, and credential module configured to provide new authentication data based on information extracted from a most recently government-recorded real property deed associated with the requesting real property owner.

### RELATED DOCUMENTS

This document is related to, incorporates by reference in its entirety, and claims the priority benefit of U.S. Provisional Patent Application No. 63/612,439 entitled “REAL PROPERTY STATE MANAGEMENT SYSTEM AND METHODS” filed on Dec. 20, 2023 by Anthony DeBono III.

### BACKGROUND OF THE INVENTION

Real property structures can be built based on construction plans that include particular measurements, materials, and mechanical, HVAC (heating, ventilation, and air conditioning), electrical, and fire specifications. Moreover, such structures can include various additional aspects, including but not limited to appliances, furniture, treatments, colorizations, flooring, etc.

### SUMMARY OF THE INVENTION

An object of the present invention is to provide a Real Property State Management System (“RPSMS”).

Another object of the present invention is to provide a RPSMS that can provide convenience and security to owners of real property structures, such as residential structures, commercial buildings, and other real property structures.

A further object of the present invention is to provide a RPSMS that can maintain a current state of a real property structure.

In an exemplary embodiment of the present invention, a RPSMS can include a database, and at least one of an authentication module, an interaction module, a credential module, a scheduling module, and a health module.

In another exemplary embodiment of the present invention, a RPSMS can include a database, an authentication module, and an interaction module, and a credential module.

In exemplary aspects of the invention, a database can contain a plurality of real property records; and a real property record can include a unique real property address associated with a real property structure, owner data associated with the real property address, and at least one of one or more structure records associated with the real property structure, one or more construction records so associated, and one or more appliance records so associated.

In another exemplary aspect, an authentication module can be configured to authenticate a real property owner for at least one of the plurality of real property records based on authentication data provided by a real property owner.

In a further exemplary aspect, an interaction module can be configured to process an interaction request provided by an authenticated real property owner and associated with a particular real property address associated with the authenticated real property owner. In an exemplary aspect of the present invention, a database be accessed remotely by real property owners.

In yet another exemplary aspect, a credential module can be configured to provide new authentication data to a requesting real property owner based on information extracted from a most recently government-recorded real property deed associated with the requesting real property owner.

In still another exemplary aspect, the extracted information can include a mailing or property address and/or a legal owner name.

In another exemplary aspect, a credential module can be configured to provide new authentication data to a requesting real property owner based on the extracted information and at least one non-owner human action based at least in part on the extracted information.

In a further exemplary aspect, a scheduling module can be configured to provide a maintenance reminder based at least in part on a data instance corresponding to at least one of a structure record, a construction record, and an appliance record.

In yet a further exemplary aspect, a health module can be configured to assign a health score to an appliance based at least in part on an appliance record and/or a maintenance history of the appliance.

### BRIEF DESCRIPTION OF DRAWINGS

FIG. 1 illustrates a logical representation of a real property state management system according to an exemplary embodiment of the present invention.

FIG. 2 illustrates an exemplary database according to the present invention.

FIG. 3 illustrates an exemplary authentication module configured to receive authentication data from a real property owner.

FIG. 4 illustrates an exemplary interaction module configured to receive an interaction request from a real property owner.

FIG. 5 illustrates an exemplary credential module configured to receive a credential request from a requesting owner and to provide new credential data based on extracted information from a real property deed and/or non-owner human action.

FIG. 6 illustrates an exemplary scheduling module configured to generate and send a maintenance reminder to real property owner regarding an appliance, a construction aspect, or a structure aspect of a real property structure associated with the owner.

FIG. 7 illustrates an exemplary health module configured to generate a health score based at least in part on an appliance record.

### DETAILED DESCRIPTION OF THE INVENTION

It is an object of the present invention to provide a real property state management system.

It is another object of the present invention to provide a real property state management system that provides convenience and security to real property owners.

These and other objects are expressly, implicitly, and apparently provided via the illustrative embodiments and aspects described herein.

It should be noted that this disclosure includes a plurality of embodiments, each having a plurality of elements and/or aspects, and such elements and/or aspects need not necessarily be interpreted as being conjunctively required by one or more embodiments of the present invention. Rather, all combinations of all elements and/or aspects described herein can enable a separate embodiment of the present invention, which may be further claimed with particularity in one or more future filed Non-Provisional Patent Applications. Moreover, any particular structure, arrangement, and/or functional logic disclosed herein, whether expressly or implicitly, are to be construed strictly as illustrative and enabling, and not necessarily limiting. Therefore, it is expressly set forth that such structure, arrangement, and functional logic, independently or in any combination of one of more thereof, are merely illustratively representative of one or more elements and/or aspects of one or more embodiments of the present invention and are not to be construed as necessary in a strict sense.

Further, to the extent the same element or aspect is defined differently anywhere within this disclosure, whether expressly or implicitly, the broader definition is to take absolute precedence, with the distinctions encompassed by the narrower definition to be strictly construed as optional.

Illustratively, perceived benefits of the present invention can include functional utility, whether expressly or implicitly stated herein, or apparent herefrom. However, it is expressly set forth that these benefits are not intended as exclusive. Therefore, any explicit, implicit, or apparent benefit from the disclosure herein is expressly deemed as applicable to the present invention. Exemplary functional utility provided by a real property statement management system disclosed herein can include maintaining a current state of a real property structure, which can include one or more structure records (such as dimensions, shapes, configurations, colors, styles, of its interior and exterior structures); appliance records (e.g., health scores, aspects of appliances currently used, including access credentials for third party service providers relating thereto); and one or more construction records (e.g., plumbing, mechanical, and electrical systems and components). Further, additional utility can include providing secured access to the system through binding access control to government recorded information.

It should be noted that the present invention contemplates that a real property owner can include one or more natural persons, legal entities, and authorized agents thereof. Accordingly, given the context presented, one of ordinary skill will understand and appreciate the scope of this disclosure.

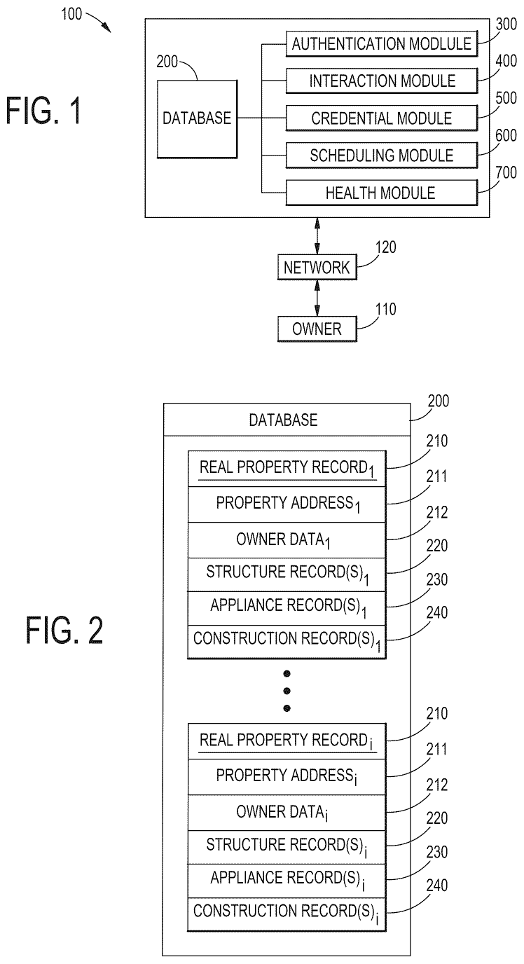

As illustratively shown in FIG. 1, the present invention provides a Real Property State Management System (“SMS”) 100 that can be accessible by an authorized user 110 via a computer network 120, such as the Internet, a wide area network, and/or a local area network. Notably, an SMS can optionally be accessible, in whole or in part, in a non-network manner insofar as desired.

As further illustrated, SMS 100 can include a database 200 and at least one of an authentication module 300, an interaction module 400, a credential module 500, a scheduling module 600, and a health module 700.

According to the present invention, database 200 can be implemented via any functionally compatible database model desired, such as a relational, hierarchical, object-oriented, star, or a hybrid of any one or more thereof, for example and not in limitation.

As illustrated in FIG. 2, database 200 can include a plurality of real property records 210, each having a unique property address 211 and owner data 212 associated with a real property structure; one or more structure records 220; one or more appliance records 230; and one or more construction records 240, all such records being associated with such a real property structure.

In an exemplary aspect of the present invention, a unique property address 211 can include a street address and a zip code of a respective real property structure, for example and not in limitation. Further, owner data 212 can include a legal name, for example and not in limitation. Notably, owner data 212 can further include additional data (e.g., a social security number, etc.) to maintain uniqueness between owners, or alternatively be provided as a social security number, drivers license number, or any other data to maintain uniqueness between owners.

In another exemplary aspect, structure record 220 can include at least one data instance representing an aspect of a real property structure associated therewith. For example and not in limitation, such as an aspect(s) can correspond to an interior or exterior dimension, volume, surface area, position, location, measurement, color, etc. of a real property structure, which can include one or more walls, floors, ceilings, trim, openings, windows, doors, stairs, furniture, or any other similar feature or aspect of the real property structure. Further, such data instances can be provided as raw data (e.g., measurements in inches, feet, etc.) and/or image and/or video data thereof. Still further, such data instances can further include data corresponding to type, color, paint color/type/brand, installation/application date, maintenance history, and any other structural aspects of a real property structure consistent with the present invention.

In another exemplary aspect, appliance record 220 can include one or more data instances associated with an appliance within, attached to, or located in association with a real property structure associated with the real property record. In a further exemplary aspect, such one or more data instances can represent aspects of the appliance associated with the application record, such as an appliance name or type (e.g., washer, dryer, refrigerator, door bell, alarm system, air handler, compressor, etc.), make, model, serial number, color, one or more images or videos thereof, physical dimensions, owner and/or service manuals, installation date, age, maintenance and/or service history/intervals, warranty documents, and/or access credentials (e.g., for smart appliances), for example and not in limitation.

In another exemplary aspect, construction record 240 can include one or more data instances associated with at least one construction aspect of a real property structure associated therewith. According to the present invention, a construction aspect can include, for example and not in limitation, the following: building documents; architectural drawings; structural drawings; mechanical, electrical, plumbing and/or fire drawings; schedules (e.g., lists of materials, fixtures, and/or equipment specified); installation/construction dates; maintenance dates, and any other information relating to the construction of a real property structure.

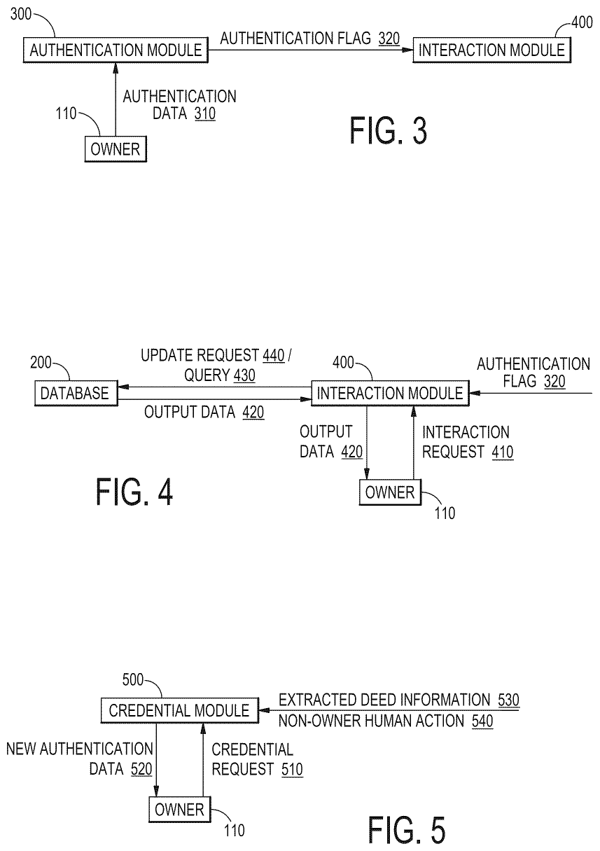

In a further exemplary aspect, authentication module 300 can be configured to authenticate a real property owner 110 so as to allow access to real property record(s) 210 associated with the real property owner. As illustrated in FIG. 3, authentical module 300 can be configured to receive authentication data 310 (e.g., a login/password combination, for example and not in limitation) from real property owner 110 to effectuate an authentication of the owner as to one or more real property records 210 associated with the owner.

In an exemplary aspect, authentication data 310 can be any one or more data instances that can be used, at least in part, by authentication module 300 to authenticate real property owner 110, so as to provide an authenticated real property owner with access to system 100 with respect to real property record(s) associated with the real property owner. For example and not in limitation, authentication data 310 can be a cryptographic hash input, a login-password combination, one or more key splits, or any other one or more expected data instances with which a user can be authenticated. In another exemplary aspect, authentication module 300 can communicate an authentication flag 320 to interaction module 400 to set an authenticated state of owner 110.

In another exemplary aspect, as illustrated in FIG. 4, interaction module 400 can be configured to process an interaction request 410 provided by an authenticated real property owner and associated with a particular one or more real property structures associated with the authenticated real property owner. According to the present invention, an interaction request can be a query 430 against or an update request 440 for one or more real property records 210 associated with a requesting owner 110. In an exemplary aspect, responsive to a query, interaction module 400 can forward to owner 110 output data 420.

In still another exemplary aspect, as illustrated in FIG. 5, credential module 500 can be configured to receive a credential request 510 from a requesting real property owner 110, and thereafter provide the owner with new authentication data 520 based on information 530 extracted from a most recently government-recorded real property deed (not shown) associated with the requesting real property owner. In an exemplary aspect, information extracted from such a deed can be a legal name of an owner and/or a property address, for example and not in limitation.

In another exemplary aspect, credential module 500 can alternatively or additionally require at least one non-owner human action 540, such as the confirmation of ownership status by referencing a recorded property deed, at least one of a physical mailing or delivery to, or confirmation at, the property address recorded in the system and/or cited in a most recently government recorded property deed, an in-person identity confirmation (e.g., checking a government-issued identification card), an in-person confirmation of possession of seed data communicated in a prior communication, required confirmation(s) only at the property address recorded in the system or cited in a recorded property deed, etc. For example and not in limitation, non-owner human action 540 can include at least one trusted human action logically bound to the legal name or property address extracted from a most recently government recorded property deed, such as for example and not in limitation, a physical delivery of new authentication data 520 or seed data to such a property address, to such a property address with a signature requirement, to such a property address with a government photo identification verification, etc.

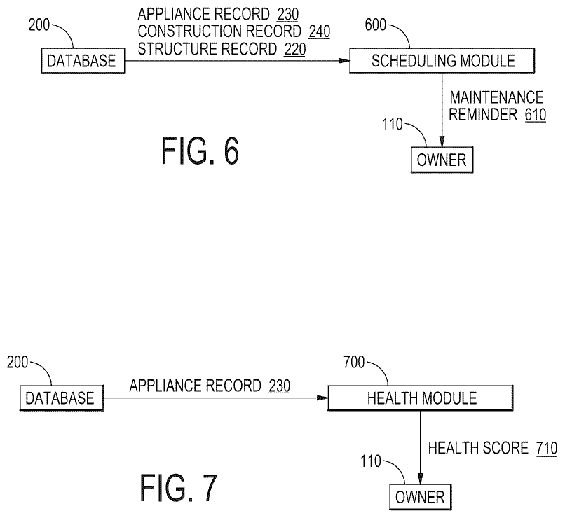

In an additional exemplary aspect, as illustrated in FIG. 6, scheduling module 600 can be configured to generate and send a maintenance reminder 610 to real property owner 110 regarding an appliance, a construction aspect, or a structure aspect of a real property structure associated with the owner. In an exemplary aspect, scheduling module 600 can analyze one or more of a structure record 220, an appliance record 230, and a construction record 240 to determine whether a maintenance event is required. For example and not in limitation, scheduling monitor 600 can analyze an appliance record 230 to determine that eleven months has passed since the dryer vent has been cleaned, and accordingly, can send maintenance reminder 610 to an owner 110 that such maintenance is due in one month. As another example, scheduling monitor 600 can analyze a structure record 220 to determine that nine years has passed since the original exterior paint had been applied, and accordingly, can send maintenance reminder 610 to an owner 110 that such maintenance is due in one year.

In an additional exemplary aspect, as illustrated in FIG. 7, health module 700 can be configured to generate a health score 710 based at least in part on an appliance record 230. According to the present invention, health score 710 can provide real property owner 110 with a current perspective on the state of an appliance, such as the likelihood of failure, current maintenance needs, etc. In an exemplary aspect, in generating health score 710, health module 700 can consider an appliance's age, maintenance history, repair history, repair/performance/failure history of same unit belonging to others, reviews of owners, or any other metric relating to performance and/or efficiency of the appliance.

It will be apparent to one of ordinary skill in the art that the manner of making and using the claimed invention has been adequately disclosed in the above-written and attached description of the exemplary embodiments and aspects of the present invention.

It should be understood, however, that the invention is not necessarily limited to the specific embodiments, aspects, arrangements, and components shown and described above, but may be susceptible to numerous variations within the scope of the invention. For example, while particular data instances are described for uniquely referencing records and logically associating records and/or data instances, it will be understood that any functionally consistent one or more data instances can be used effectively or actually as primary keys or for logical association purposes, insofar as functionally consistent with the present invention.

Therefore, the specification and drawings are to be regarded in an illustrative and enabling, rather than a restrictive, sense.

Accordingly, it will be understood that the above description of the embodiments of the present invention are susceptible to various modifications, changes, and adaptations, and the same are intended to be comprehended within the meaning and range of equivalents apparent to one of ordinary skill in the art.

1. A real property state management system, comprising:
a database containing a plurality of real property records, each real property record having a unique real property address associated with a real property structure, owner data associated with the real property address, and one or more structure records associated with the real property structure;
an authentication module configured to authenticate a real property owner for at least one of said plurality of real property records based on authentication data provided by the real property owner;
an interaction module configured to process an interaction request provided by an authenticated real property owner and associated with a particular real property address associated with the authenticated real property owner; and
a credential module configured to provide new authentication data to a requesting real property owner based on information extracted from a most recently government-recorded real property deed associated with the requesting real property owner.

2. The system of claim 1, wherein the extracted information includes a mailing address.

3. The system of claim 1, wherein the extracted information includes a legal owner name.

4. The system of claim 1, wherein said credential module is configured to provide the new authentication data to the requesting real property owner based on the extracted information and at least one non-owner human action based at least in part on the extracted information.

5. The system of claim 4, wherein the extracted information includes a mailing address.

6. The system of claim 5, wherein the non-owner human action includes a physical delivery of information to the mailing address.

7. The system of claim 4, wherein the extracted information includes a legal owner name.

8. The system of claim 1, wherein the one or more structure records includes a data instance corresponding to an interior dimension of a wall.

9. The system of claim 1, wherein the one or more structure records includes a data instance being one of an image data and a video data.

10. The system of claim 1, wherein at least one of the plurality of real property records further has a construction record that includes at least one data instance corresponding to a building plan.

11. The system of claim 10, further comprising a scheduling module configured to provide a maintenance reminder based at least in part on the at least one data instance corresponding to the building plan.

12. The system of claim 1, wherein at least one of the plurality of real property records further has an appliance record that includes at least one data instance corresponding to an appliance.

13. The system of claim 12, further comprising a scheduling module configured to issue a maintenance reminder based at least in part on the appliance record.

14. The system of claim 12, further comprising a health module configured to assign a health score associated with the appliance based at least in part on the appliance record.

15. The system of claim 12, wherein the at least one data instance corresponding to the appliance includes a maintenance history associated with the appliance, and said system further comprises a health module configured to assign a health score associated with the appliance based at least in part on the at least one data instance corresponding to the appliance.
